(19) United States
(12) Patent Application Publication
(10) Pub. No.: US 2008/0302995 A1
(43) Pub. Date: Dec. 11, 2008

(54) Wear Resistant Design for Plastic Valve Stem Installations

(76) Inventor: Paul W. O'Brien, Tunkhannock, PA (US)

Correspondence Address: CHARLES A. WILKINSON, ESQ., 68 EAST BROAD STREET, P. O. BOX 1426, BETHLEHEM, PA, 18016-1426, US

(21) Appl. No.: 11/936,661

(22) Filed: Nov. 7, 2007

Related U.S. Application Data
(60) Provisional application No. 60/857,291, filed on Nov. 7, 2006.

(51) Int. Cl. F16K 51/00

(52) U.S. Cl. 251/366

(57) ABSTRACT

An arrangement is provided to relieve the wear in a vibration type indicator for a valve by providing a stress relieving opening behind one of two temporarily interengaging structures formed of a groove and a projection particularly in a plastic construction.

### REFERENCE TO RELATED APPLICATION

This application claims priority from the U.S. Provisional Application 60/857,291 filed Nov. 7, 2006 by its present inventor.

### BACKGROUND OF THE INVENTION

1. Field of the Invention

This invention relates a wear resistant rotary valve stem installation and more particularly to the use and construction of wear resistant rotary plastic valve stem arrangements making use of detents on the surface of such stem and more particularly still to the mounting of a rotary valve stem having an integral detent on the side adapted to be temporarily detained by a nub in the side of a plastic housing for the valve stem and which has particular utility as an arrangement for providing wear resistant detection and indexing means for the temporary positioning particularly of a valve stem in a position particularly for releasing bath salt solution into a shower installation at predetermined rates determined by the setting of a valve arrangement and a lever operating such arrangement.

2. Discussion of the State of the Art

In the adjustment of valves or the adjustment of other set points, it is often desirable to turn the valve or other control lever a certain number of indexing “clicks” to find a particular set point. Such clicks or momentary detents of the adjustment means may be created or caused by momentary impediments to further movement of the adjustment means by falling or entrance of a metal or other detent into an orifice or the like or into a particularly spaced series of orifices adjacent the valve stem or the like. For example, a rotary valve stem or the like might have a section of spacing metal attached to the side in an open arrangement on the side and might have a metal or plastic detent on the surface which would at specific points be spring biased to enter an orifice in an adjoining plate marking a certain position or adjustment of the valve stem. The advantage of such a simple system is that the operator need not carefully position the main valve stem or the like either by sight or mere “feel”, but may simply turn the valve stem until its indicator enters an orifice, groove or the like indicating thereby the particular radial position of the valve stem or the like at some predetermined position.

While such detent systems work fairly well in metal construction or movable items formed of metal, in the use of the presently more usual commercial plastic materials it has been found that if there is, for example, a raised detent or bump on the side of a plastic valve stem or even more likely a groove in a rotary valve stem indicating a particular position of the valve as a whole with a corresponding detent in the form of a nub or bump upon a retainer or the like inside which the valve stem rotates and into which grooved detent the nub or bump may enter, providing thereby a detectable bump or click which the user can feel and interpret as the proper position of the valve stem to be adjusted, while the arrangement works well for a limited number of uses, the sides of the orifice either quickly wear away themselves or, alternatively break away the plastic detent on the valve retainer or alternatively such detents quickly wear away the sides of the orifice so that its position becomes rapidly less and less well defined thereby quickly rendering the desired indexing function either inoperative or seriously decreased. The use of metal coverings for the detents and the lining of the orifices may alleviate such problem temporarily, but are both expensive and relatively shod lived in their effect.

### 3. DESCRIPTION OF THE INVENTION

The present inventor has found that plastic detents can be usefully used on or in connection with plastic valve stems mounted in plastic journals or the like, with minimal wear and long working life provided only that a further orifice is machined out of the plastic matrix of the valve housing under or over a nub or raised portion in the side of the plastic retainer for the valve stem. This additional opening in the plastic, either under the nub or raised portion, or in some instances, in the backing for the plastic in which the detent orifice is positioned, allows the section of the plastic in which the orifice or nub is provided or from which such nub projects to act itself as a partial spring which can flex inwardly as the bump or detent of the adjoining surface passes by while being compressed. It has been found that such simple alteration of the structure, for example, of a valve retainer solves the problem of heavy wearing away and breakage of the plastic allowing very economical and durable position detecting structures to be provided made completely of plastic. The detent-relieving opening could also be provided in the valve stem under either a detent or an orifice in the surface of the valve stem. However, it is preferred that the stress relieving opening in the plastic under an operating portion of a valve stem should rather than being positioned under or adjacent to an operating portion of a valve stem, instead should be in the surrounding or matrix structure of whatever device is concerned, since the stem of a valve has less mass in most cases than the surrounding or matrix material about the stem and the side or journal of the valve stem is more likely to be accessible to machining in order to form the stress relieving orifice. Other possible methods of forming a stress-relieving orifice at the proper location could be used. For example, in the pressure or other forming of the matrix, a small hollow bead or pre-hardened hollow plastic structure could be positioned or implanted in a strategic position leaving an opening directly under where a detent is formed upon a circumferential positioning structure of the valve stem.

### 4. BRIEF DESCRIPTION OF DRAWINGS

FIG. 1 is an elevation of a shower or bath salts dispenser for connection to a shower apparatus.

FIG. 2 is an exploded view of the shower dispenser apparatus shown in FIG. 1 including a three-position valve body and a valve retainer for retaining the valve member in the shower apparatus.

FIG. 3 is a broken away section through the dispenser apparatus transecting the valve stem in completely open position.

FIG. 4 is an isometric view of the valve member shown in FIG. 3 removed from the dispenser apparatus showing a shallow groove extending along one side.

FIG. 5 is an isometric enlarged view of the valve retainer shown in FIG. 2 thereof in position to enter the groove on the surface of the valve body every time the valve body groove is rotated on the surface of the valve body past the nub on the retainer's inner circumference or surface and further showing an orifice or lacuna formed in the valve retainer just above or adjacent the nub.

FIGS. 6 and 7 are elevations of the shower dispenser apparatus as shown in FIG. 1 with the handle in two further alternative positions.

### 5. DESCRIPTION OF THE PREFERRED EMBODIMENTS

Nub-type sliding detent indexing means are widely used in metal construction to either temporarily hold two moving surfaces temporarily in a certain alignment with each other or to indicate the passage of one portion of one component past an adjoining component at a predetermined time or location. With the increasing use of plastic construction, however, difficulty has been encountered because plastic being softer than metal quickly breaks or wears away if in the form of a nub or raised portion passing over or next to a closely adjacent surface. This problem has usually been solved by metal facing or other strengthening of the two surfaces which is costly or by using some other position holding or indexing system when working with plastic construction. The present inventor has found, however, that the wear of such system or arrangements can conveniently and effectively be solved by the use of a stress reducing lacuna or opening just under the surface of the stressed part thereby providing a simple spring action which does not interfere with indexing, but alleviates wear.

In FIG. 1 there is shown an elevation of a shower dispenser apparatus in accordance with the invention and incorporating the present invention. Such shower dispenser apparatus 11 may be threadedly attached to a shower pipe or outlet 13 by means of rotatable coupling 15. The upper half of the dispenser mechanism 17 has projecting from one side more or less opposite the shower coupling 15 a shower head 19 from which water issues in the normal manner when the shower is turned on. At the bottom of the shower dispenser apparatus is a preferably transparent bath salts container, or bowl 26 into which solid but solvable bath salts may be placed by removing the lower container or bowl 26 from the upper portion 17 of the dispensing mechanism in the form of a valve housing 21 the interior of which is generally shown in exploded view as shown in FIG. 2. Such mechanism is generally in the form of a valve housing 21 which houses a valve mechanism effectively encapsulated in left and right side covers 23 and 25. The preferably transparent globe-type salts container 26 is adopted to be connected to the valve housing 21 by a bayonet-type connection maintained water tight by “O”-ring 27. A valve body 29 or combined valve body and stem 29a is provided in one side of the valve housing 21 and is shown more in detain in cross-section in FIG. 3. A handle 31 is provided on the outer or stem end of the valve 29 best shown in FIG. 3 and provides a means to rotate the valve, which, rather than moving in and out as the result of being threaded into the valve housing as in many valve stems, merely rotates in the housing. In the example shown, the valve has three principal rotary positions. In the first of these as shown in FIG. 1 with the handle 31 extending upwardly the connection through the valve body 29 is closed off and no liquid can flow either way through the valve from the shower stream to the bath salts globe or container 6. This is preferably arranged or made to constitute one end of the range of valve movement and provides a shut off position in which orifices in the valve body do not allow any liquid flow. The other end of the range of movement or rotation of the valve is shown in FIGS. 3 and 7 with the handle more or less downwardly inclined and with the liquid orifices in the end of the valve completely overlapping or lined up with an orifice leading into or intersecting with the flow stream between the showerhead and the shower inlet pipe 13 through the shower dispenser structure. A gasket 51 about the larger orifice in the rear of the valve head receiving orifice which leads to the surface of the globe receiving connection on the lower portion of the valve housing 21 prevents leakage of liquid between the inner valve face and the liquid passage 49 to the bath salts containing globe 26. Furthermore, since the gasket 51 provides very secure contact between the orifice 47 in the valve body and either the blank end face 39a of the valve body 39 or the orifice 33 in face 39a, slow rotation of the valve body 39 will cause a slow initial but rapidly increasing flow of liquid through the orifice until maximum flow is achieved.

FIG. 4 shows an isometric view of the valve body 29 and valve body stem 29a removed from the valve housing showing a flow orifice 33 on the end which it will be understood, leads internally to an orifice or channel 35 on the surface which intersects with a water inlet and entrance orifice 37 leading from the principal flow passage 39 of water through the valve housing to the peripheral surface of the valve head where it intersects the channel 35 on the surface of the valve body when the two are aligned. The ends of the range of rotation of the valve head as shown in FIG. 1 for a completely off or closed position and shown in FIG. 7 and also in cross-section view 3 for a completely open position are marked or determined with stops, not shown, which determine the limits of rotation or travel of valve body 29. These can be felt easily by the shower user when rotating the valve body, since the on-off lever will not go farther in either of these directions A user can also estimate or determine the middle position by sight or angular position of the handle 31, but the actual position of the valve stem is then only approximately known. It is, therefore, desirable to have some positive indication of a half open position. This could be indicated by a position indicator of some form. However, when a user is taking a shower, such user is not usually in a very good position to try to read indications such as a dial and the like to obtain an indication of the setting of a valve. Off or on indications by reaching the end of valve travel and having the valve close with a clockwise motion and open with an anti-clockwise motion is broadly acceptable in opening and closing a valve by feel, but for any in-between position it is desirable to have some other reliable indication. It has been known for many years that in such a situation, generating either an audible “click”, or even an inaudible click that can be felt with the fingers, is a practical method to use. In general also the generation of such audible or kinesthetic indication of position are well known in both metal composition movable systems such as valves and other mechanisms and plastic construction movable systems. However, plastic materials having a relatively lesser hardness and wear resistance compared to metals and the like have the disadvantage that the plastic tends to wear relatively quickly with not only a relatively quickly declining audible or kinesthetic cue, i.e. a cue detected through feel such as a momentary hesitation or stop or vibration, and/or a declining audible cue as the plastic sections become worn or deformed. Yet in modern production, plastic parts where possible are frequently highly desirable because of cost factors and also quite frequently because of corrosion factors when considering or comparing against other materials.

The present inventor has devised a novel and effective method and means allowing plastic click producing means to be used with very substantially less wear and breakage plus a considerably greater degree of efficiency both as to effectiveness, durability and cost maintenance.

In the present application, mechanical arrangement for producing a click, bump or hesitation at the midpoint, as shown more particularly in FIGS. 4 and 5 of the appended drawings, the extended polymeric or plastic valve body 29 is provided with a shallow groove 34 on its surface at least in the position which when the shower dispenser is assembled underlies the valve retainer 38 which fits around and over the valve body to retain it in position. At the same time, the inner surface of the retainer 39 abutting the valve body in use is provided with a plastic nub, bump or node 41 which when the retainer is assembled about the valve body to retain it in place by three fastenings such as machine screws 43 of either metal or plastic serves to descend into, or snap into, the groove 34 in the valve body, see FIGS. 4, 5 and 3. The sudden entrance or descent of the nub or node 41 into the groove 34 can be felt by the shower user as a click or vibration in the handle 31 indicating that the flow opening of the shower dispenser is half open and as a result, at this point or juncture, of the orifice 35 at the end of the valve body being half overlapped with the orifice 47 in the valve body 17 so there is a half constricted channel leading from the shower water channel through which water from the shower to the showerhead passes through channel 49. See, for example, FIG. 3 which shows the orifice 35 on the head or end of the valve body 29 and the orifice 47 body of the valve housing 21 being completely aligned by use of handle 31 all the way down or approximately 45 degrees from vertically down, see FIG. 7. It can be seen that when the handle is rotated all the way up the two orifices will be completely misaligned and no liquid will flow. In the half way position, on the other hand, as illustrated by FIG. 6 the gasket about the orifice in the back or head of the valve opening will be half overlapped with the orifice in the valve head decreasing the effective opening by one half and the flow by approximately one half.

When the half way position of the valve head is assumed, the groove or slot in the side of the valve head will be stabilized by the slipping of the nub 41 on the inner diameter of the valve retainer 38 into the groove 34 upon the surface of the valve body. Additional force applied will then force the nub 41 out of the groove 34 on the valve head and allow the valve head to continue its rotational movement. It has been found, however, that if the clearance of the surface of the valve head and the surrounding round valve body orifice is relatively close as is necessary to essentially seal the surface of one to the other, rapid wear occurs. With such close tolerance, the nub 41 will be quickly worn down and the sides of the groove 34 will likely be worn also into a slanting groove configuration until the click indicating that there is alignment between the groove and the nub will disappear and the user will not be able to determine when the center or midpoint of valve orientation has been reached. In order to substantially alleviate such wear and retain the click, it has surprisingly been found that if an orifice or lacuna 51 in the valve retainer 38 is provided in the plastic behind the nub 41 so the nub is essentially mounted on a flexible or more flexible bridge structure 53 upon which the nub is mounted, such opening will allow slight inward flexion or flexing of the plastic relieving the wear against the nub 41 and the side of the groove 37. It has been found that by the simple expedient of providing a lacuna 51 behind the nub 41, the structure of the valve can be made very much more durable and wear of the plastic is for all intents and purposes substantially eliminated. In other words, if an orifice or lacuna is positioned behind or next to either the nub or the groove or both in an polymeric structure much reduced wear is attained.

It will be evident that the lacuna could also be provided in the plastic of the valve of the valve head under the groove in the valve head or alternatively the nub could be situated in the surface of the valve head and the groove on the valve retainer. However, in general, it is more convenient and better spring action or relief of the wear will be provided if the lacuna is provided in the valve retainer because such lacuna or orifice can be positioned directly adjacent the nub and extend to both sides of the valve retainer so that it is more flexible and more likely to effectively relieve tension in the construction. It is also more satisfactory to relieve tension or stress under a nub or alternatively groove in the valve retainer than having a corresponding lacuna in the valve head which usually will have less effective mass because of being the central structure.

The invention of a lacuna or orifice preferably open on both sides under a constituting member such as a nub in a click type designation structure has been found to provide an effective way to provide reasonable and even long life in plastic construction and to be easily provided, effective in operation and inexpensive to provide.

While the present invention has been described at some length and with some particularity with respect to the several described embodiments, it is not intended that it should be limited to any such particulars or embodiments or any particular embodiments, but it is to be construed with reference to the appended claims so as to provide the broadest possible interpretation of such claims in view of the prior art and, therefore, to effectively encompass the intended scope of the invention.

I claim:

1. A stress relieving construction in an assembly having a polymeric construction of relatively moving parts with an extending portion arranged to fall into a depression upon a certain position being reached and thereby produce a vibration which can be detected by a user of the moving parts comprising:
(a) two structures relatively movable with respect to each other and in at least partly biasing contact with each other at least at one point in a length of movement, being provided with two interactive vibration providing sites activated when one of the parts reaches a predetermined relation with respect to the other part, and
(b) a lacuna provided adjacent one of the two interactive sites such as to relieve by flexion of such site material to relieve wear of the contacting structures without substantial decrease over time of resulting vibration.

2. A stress relieving construction in accordance with claim 1 wherein one of the two interactive vibration inducing means is a groove in one structure and the other is a projection on the opposed structure.

3. A stress relieving construction in accordance with claim 2 wherein the lacuna is within the polymeric material behind the projection on the one opposed structure.

4. A stress relieving construction in accordance with claim 3 wherein the lacuna is open on both sides by reason of extending through its structural part.

5. A stress relieving construction accordance with claim 4 wherein the two structures are a valve stem and a retainer for the valve stem.

6. A stress relieving construction in accordance with claim 5 wherein the lacuna and adjacent projection are provided in the valve retainer.

7. A stress relieving construction in accordance with claim 6 wherein the stress relieving construction is used in a valve for a dispensing assembly for a bath salts dispenser for use with a shower.

8. A method for increasing wear resistance of indexing nubs on the surface of plastic constructions comprising forming a lacuna under the nub in the plastic matrix.
